(19) United States
(12) Patent Application Publication
(10) Pub. No.: US 2008/0106174 A1
(43) Pub. Date: May 8, 2008

(54) Safety cabinet

(75) Inventors: Gary A. Marcus, Hoffman Estates, IL (US); Glen A. Carter, Mattoon, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Justrite Manufacturing Company, Des Plaines, IL (US)

(21) Appl. No.: 11/593,832

(22) Filed: Nov. 6, 2006

(51) Int. Cl. E05B 65/46

(52) U.S. Cl. 312/215

(57) ABSTRACT

A safety cabinet comprises an enclosure defining an opening and a door rotatably attached to the enclosure. The door is movable between an open position and a closed position, the door configured to selectively cover the enclosure when in the closed position. The safety cabinet further comprises a latch system to selectively retain the door in the closed position. The latch system can include a paddle handle to operate the latch system. The paddle handle includes a housing, an operating lever to actuate the paddle handle, and a tang. The operating lever is movable between a normal position and an operating position. The tang passes through a slot in the operating lever when the operator lever is in the normal position with an opening in the tang being accessible for receiving a padlock therethrough. The tang is configured such that when a padlock passes through the opening of the tang, the padlock will prevent the operating lever from moving to the operating position.

### FIELD OF THE INVENTION

The present invention pertains generally to a safety cabinet for flammable, combustible, or other hazardous materials. More particularly, the present invention relates to a safety cabinet having a door with a paddle handle configured to receive a padlock.

### BACKGROUND OF THE INVENTION

A safety cabinet for storing flammable or explosive materials is known in the art. Such a safety cabinet located at a plant allows for the onsite storage of flammable material. The safety cabinet can be provided to insulate flammable material stored within it from the direct effects of an external fire to prevent the flammable material from adding to the deleterious effect of the original fire. Often, either according to law or to an internal standard operating procedure, the safety cabinet is equipped with a locking mechanism, which provides an added safety feature by preventing inadvertent, improper usage of the flammable material and by allowing access to the flammable material to be restricted only to authorized personnel. However, when a container of flammable material is stored in a lockable safety cabinet, users of the safety cabinet frequently neglect to lock up such material between uses. This failure to use the locking mechanism can be through oversight or by design inasmuch as the user may prefer the convenience and heightened accessibility that result from the safety cabinet being unlocked.

Previous safety cabinets have included automatic closing systems and locks in order to better ensure that the safety cabinet remains locked and inaccessible to unauthorized personnel. Nonetheless, these devices are susceptible to being unlocked or damaged by unauthorized personnel who are able to defeat the locking means. Moreover, even when the cabinet doors are latched and locked the lock can be defeated when broken by forklifts or other heavy machinery operating in such work environments where a safety cabinet may be found or by intentional tampering by unauthorized personnel.

### SUMMARY OF THE INVENTION

To provide improved control over a safety cabinet such that unauthorized personnel cannot access the safety cabinet, the present invention provides a safety cabinet including a paddle handle that can also be locked by a padlock. The padlock represents a robust, automatic locking system that is resistant to damage and to circumvention by tampering. The padlock can serve as second locking means that increases the restrictions on access to the safety cabinet. The padlock can also be clearly visible from outside the safety cabinet so that one can quickly observe whether the safety cabinet is locked or not.

In one embodiment, there is provided a safety cabinet comprising an enclosure defining an opening and a door rotatably attached to the enclosure. The door is movable between an open position and a closed position, the door configured to selectively cover the enclosure when in the closed position. The safety cabinet further comprises a latch system arranged with the door to selectively retain the door in the closed position. The latch system, in conjunction with an automatic door closure system, provides a simple and efficient way not only to latch the cabinet door but also to effectively selectively retain the door and the handle in a latched position.

The latch system can include a paddle handle, first and second slide plates, first and second latch rods, and a reciprocally movable bullet slam latch. The paddle handle is operatively connected to the latches to selectively unlatch the latch system. The paddle handle can be disposed on the door. The paddle handle includes a housing, an operating lever to actuate the latch system, and a tang. The operating lever is moveable between a normal position and an operating position. The operating lever can include a slot configured to allow the tang to pass therethrough when the operator lever is in the normal position. The tang can have an opening configured to receive a portion of a padlock. The tang can be configured such that when the padlock passes through the opening of the tang, the padlock will prevent the operating lever from actuating the paddle handle.

These and other objects and advantages, as well as additional inventive features, of the present invention will become apparent to one of ordinary skill in the art upon reading the detailed description, in conjunction with the accompanying drawings, provided herein.

### BRIEF DESCRIPTION OF THE DRAWINGS

FIG. 1 is a perspective view of an embodiment of a safety cabinet according to the present invention.

FIG. 2 is an enlarged, fragmentary front elevational view of the safety cabinet of FIG. 1 showing a padlock lockingly mounted to a paddle handle.

FIG. 3 is a front perspective view of the paddle handle of the safety cabinet of FIG. 1 with the padlock removed therefrom.

FIG. 4 is a front perspective view of the paddle handle as in FIG. 3 with an operating lever thereof in an operated position.

FIG. 5 is a front elevational view of the safety cabinet of FIG. 1 with some internal components shown for illustrative purposes.

FIG. 6 is top plan view of the safety cabinet of FIG. 1, with a top removed for illustrative purposes, that illustrates the pair of doors in an open position.

FIG. 7 is front elevational view of paddle handle of FIG. 3.

FIG. 8 is a rear perspective view of the paddle handle of FIG. 3.

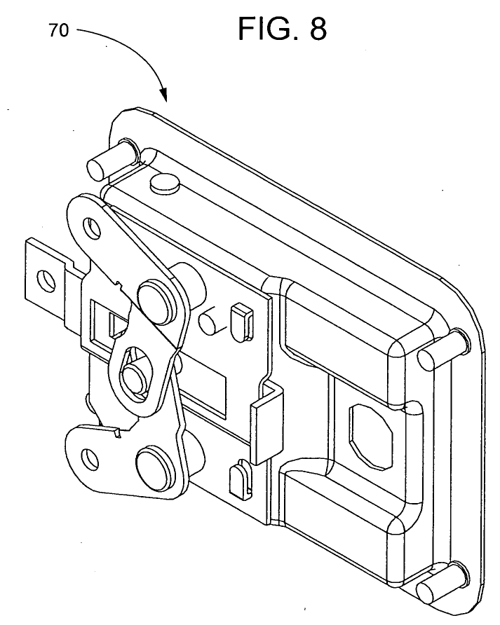

FIG. 9 is a rear elevational view of the paddle handle of FIG. 3.

FIG. 10 is a left side elevational view of the paddle handle of FIG. 3.

FIG. 11 is a right side elevational view of the paddle handle of FIG. 3.

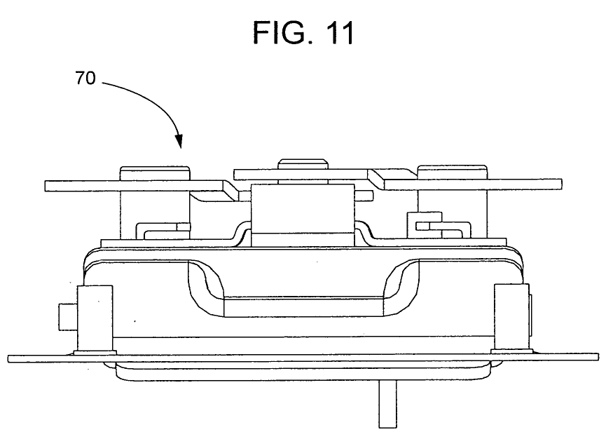

FIG. 12 is a top plan view of the paddle handle of FIG. 3.

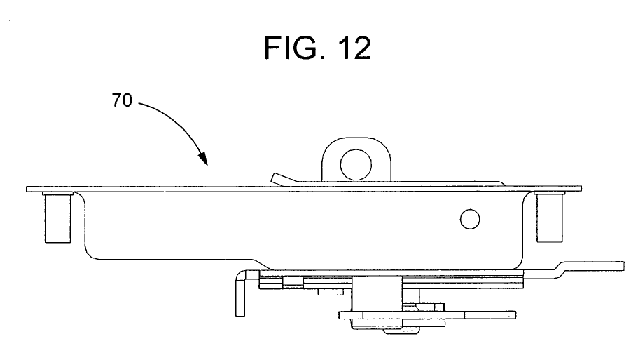

FIG. 13 is a bottom plan view of the paddle handle of FIG. 3.

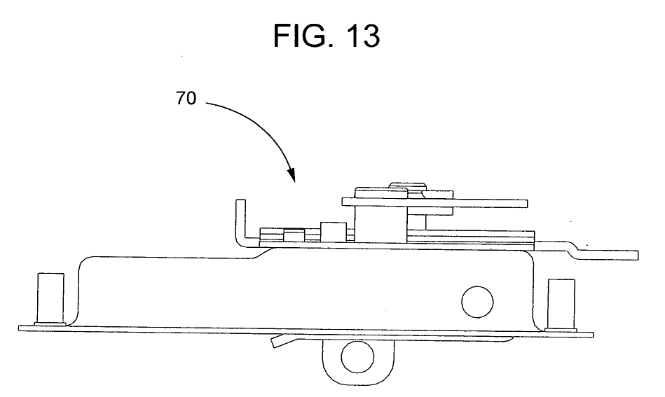

FIG. 14 is a front elevational view of a housing of the paddle handle of FIG. 3.

FIG. 15 is a front elevational view of the paddle handle of FIG. 3 with the operating lever removed for illustrative purposes.

FIG. 16 is a rear perspective view of the operating lever of the paddle handle of FIG. 3.

FIG. 17 is a rear elevational view of the operating lever of FIG. 16.

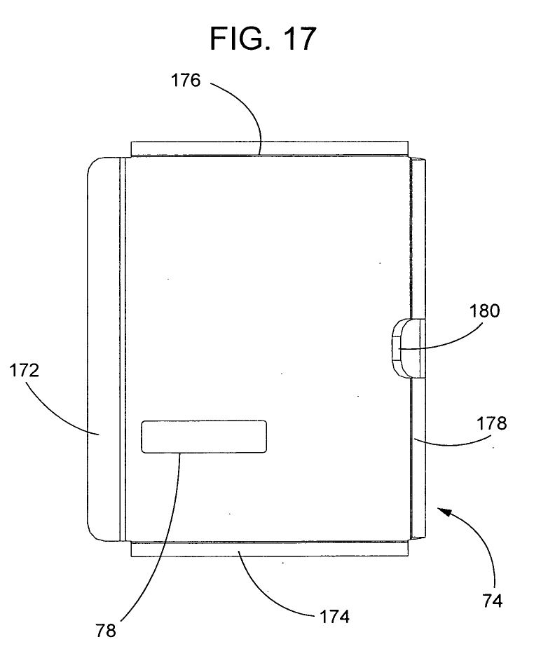

FIG. 18 is a perspective view of the tang of the paddle handle of FIG. 3.

FIG. 19 is a left side elevational view of the paddle handle of FIG. 3 with the housing removed for illustrative purposes.

FIG. 20 is a perspective view of a slide of the paddle handle of FIG. 3.

FIG. 21 is a perspective view of a back plate of the paddle handle of FIG. 3.

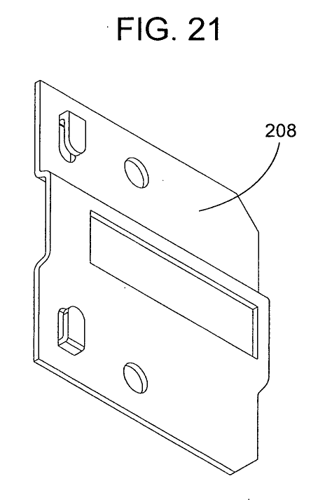

FIG. 22 is a front elevational view of the right door of the safety cabinet of FIG. 1 with some internal components thereof shown for illustrative purposes.

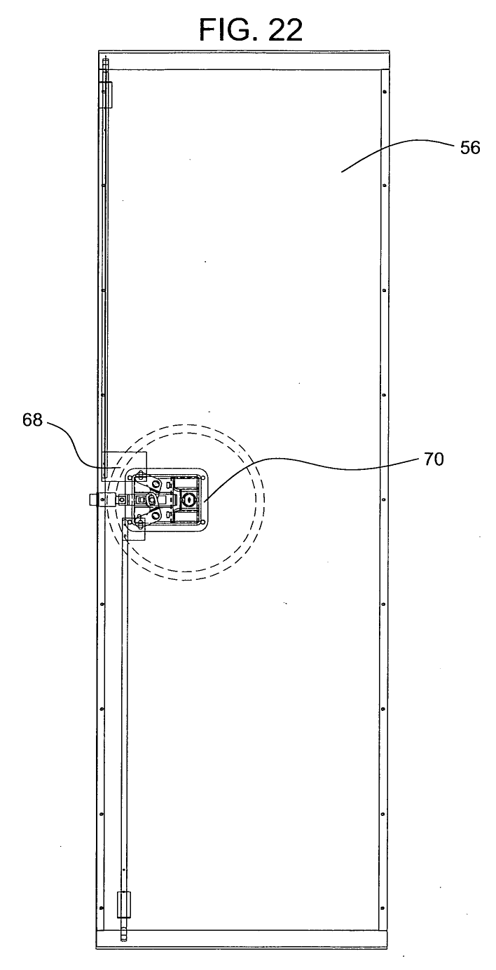

FIG. 23 is an end elevational view of the right door of FIG. 22.

FIG. 24 is an enlarged, fragmentary front elevational view of the latch system of the safety cabinet of FIG. 1.

FIG. 25 is an enlarged, fragmentary front elevational view of the latch system of FIG. 24 that shows the latch system in a released position.

FIG. 26 is a partial front elevational view of another embodiment of a safety cabinet having a paddle handle and a padlock in accordance with the present invention.

FIG. 27 is a front elevational view of the paddle handle of FIG. 26 with the operating lever removed for illustrative purposes.

FIG. 28 is a perspective view of another embodiment of a safety cabinet according to the present invention.

### DETAILED DESCRIPTION OF EMBODIMENTS OF THE INVENTION

In the following description, reference is sometimes made to the “left,” “right” “top,” “bottom,” or other regions of the safety cabinet and its various components. It should be understood that these terms are used solely for convenient reference, inasmuch as the safety cabinet may be used omnidirectionally.

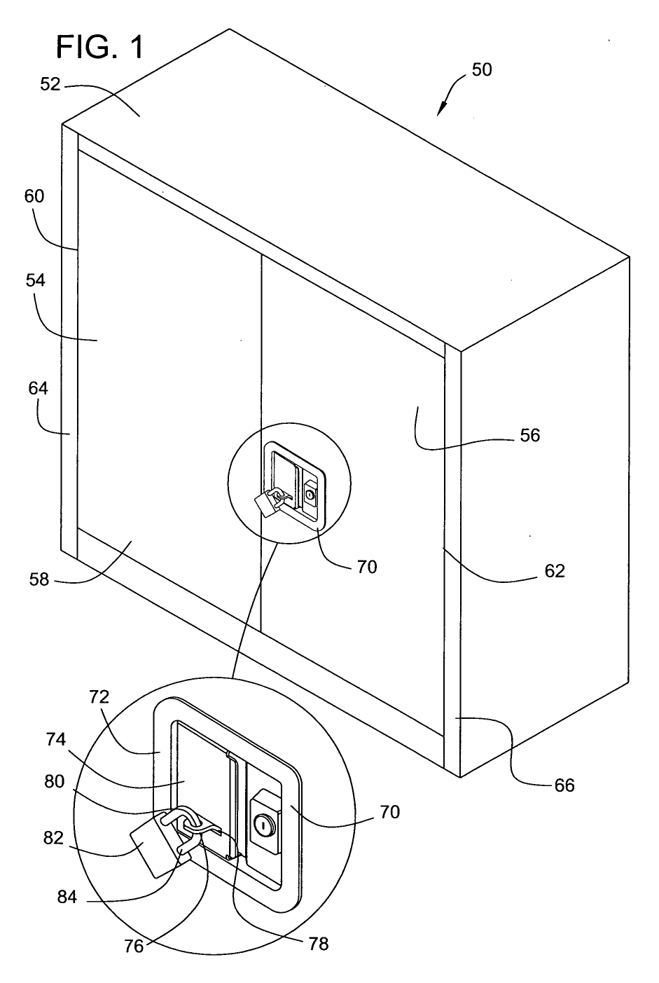

Turning now to the drawings, there is shown in FIG. 1 an illustrative fireproof safety cabinet 50 according to an embodiment of the present invention. The safety cabinet 50 can be similar in construction to a safety cabinet shown and described in U.S. Pat. No. 6,729,701 to Carter et al., which is herein incorporated by reference in its entirety. Systems and components of a safety cabinet not described in detail herein can be identical to the corresponding systems and components described in U.S. Pat. No. 6,729,701.

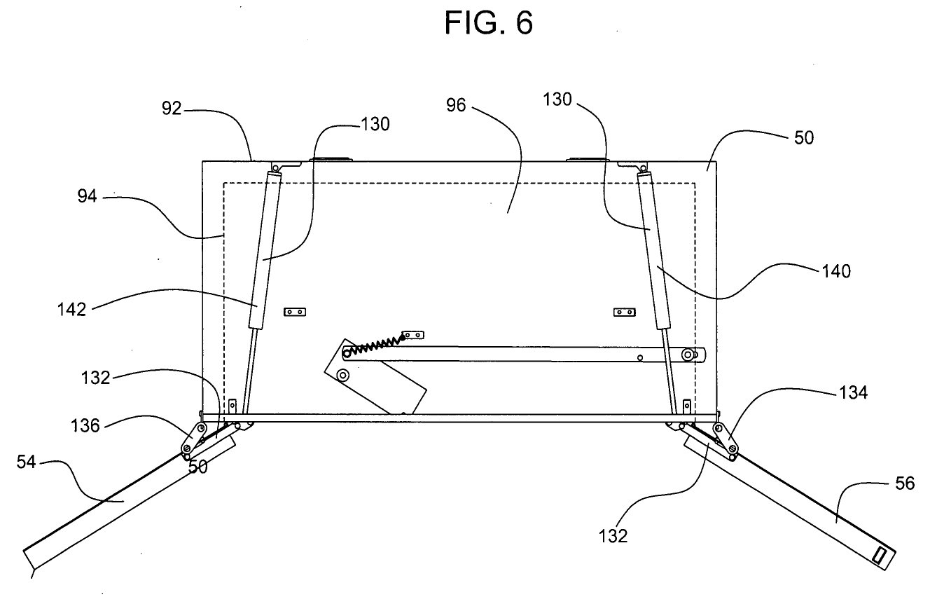

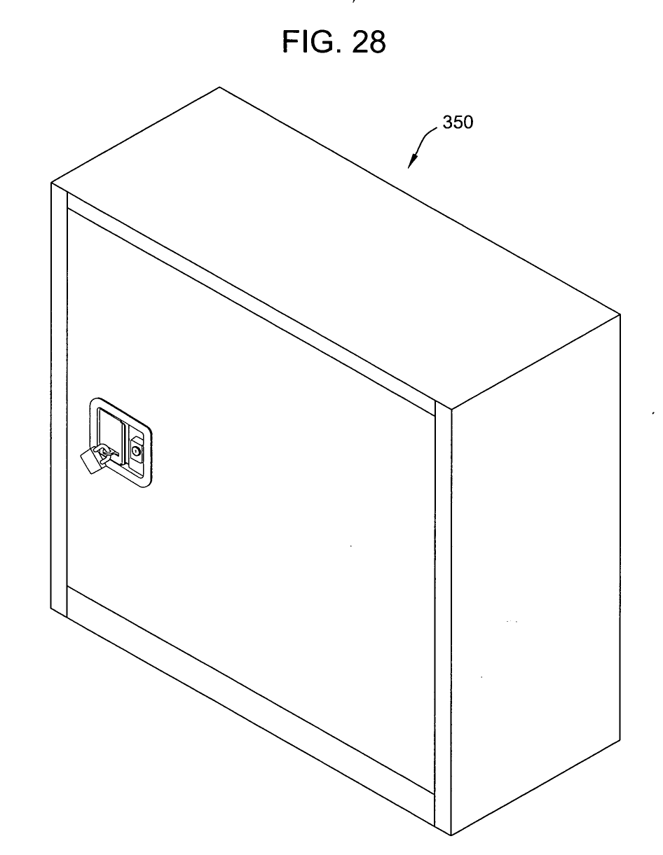

The safety cabinet includes an enclosure 52 having a left door 54 and a right door 56. The safety cabinet 50 can be used to store, for example, flammable liquids, flammable waste, corrosives, pesticides, or combustible waste. The left and right doors 54, 56 selectively cover the opening 58 of the enclosure 50. The doors 54, 56 can be moved from a closed position, as shown in FIG. 1, to an open position, as shown in FIG. 6. Referring to FIG. 1, the left door 54 and the right door 56 are preferably rotatably mounted to the enclosure 50 by respective left and right hinges 60, 62. The left hinge 60 is mounted to the left jamb 64 of the enclosure 52 and the left door 54. The right 62 hinge is mounted to the right jamb 66 of the enclosure 50 and the right door 56. The left and right hinges 60, 62 both extend substantially the full height of the respective door. It will be understood that in other embodiments, a safety cabinet 350 can include a single door to selectively cover the opening of the enclosure, as shown in FIG. 28.

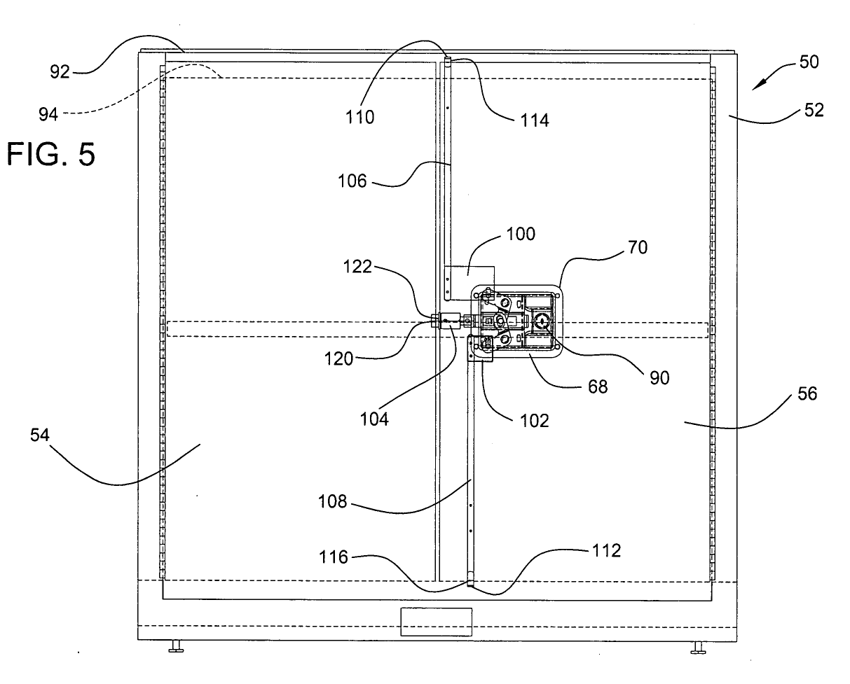

Referring to FIGS. 1 and 5, the safety cabinet 50 includes a latch system 68, having a paddle handle 70. The latch system 68 controls the opening of the safety cabinet doors 54, 56 through actuation of the paddle handle 70. The latch system can be configured to automatically latch the doors such that the paddle handle need not be actuated to latch the doors in the closed position. The paddle handle 70 includes a housing 72, an operating lever 74 to actuate the latch system 68, and a tang 76. The operating lever 74 includes a slot 78 configured to allow the tang 76 to extend therethrough when the operating lever 74 is in a normal position. The tang 76 can have a hole 80 therethrough to receive a padlock 82. The tang 76 can be configured such that when a locking arm 84 of the padlock 82 passes through the hole 80 of the tang 76 and is locked, the padlock 82 will prevent the operating lever 74 from actuating the paddle handle 70. The padlock 82 can be any suitable padlock such as those commercially available from a multiplicity of sources, such as from Master Lock Co., LLC of Milwaukee, Wis., for example. The padlock can be key-operated or can be a combination lock.

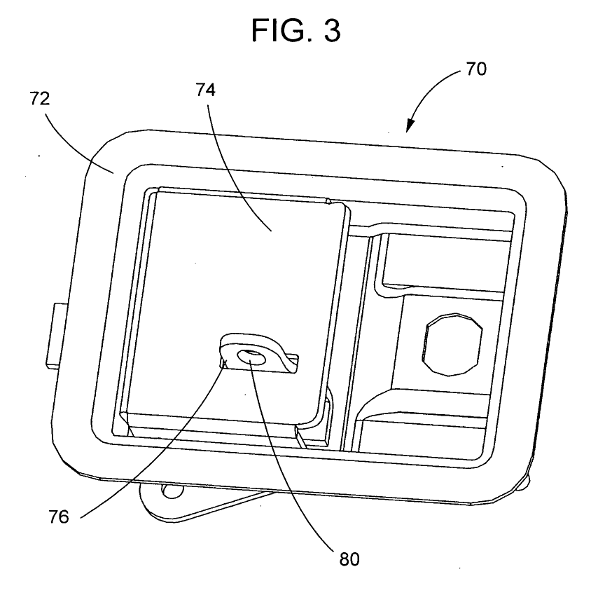

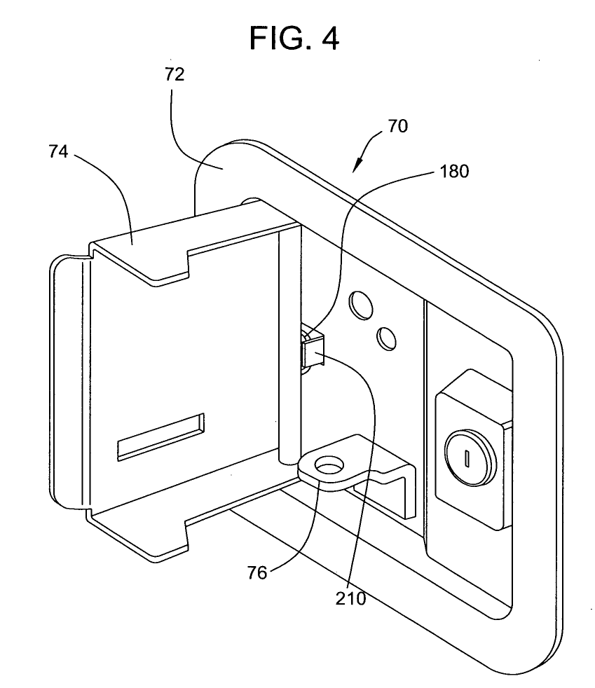

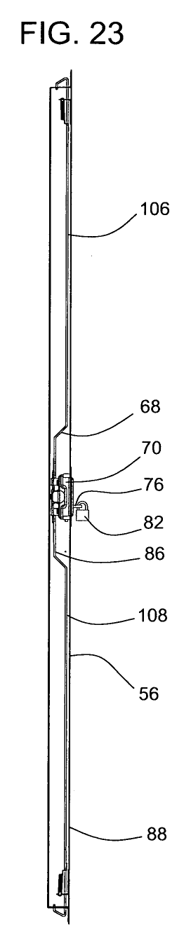

Referring to FIG. 3, the padlock can be removed from the tang 76. When the padlock has been removed, the operating lever 74 is moveable relative to the housing 72 between a normal position, as shown in FIG. 3, and an operating position, as shown in FIG. 4. The operating lever 4 is biased by a spring to the normal position. Referring to FIG. 23, the paddle handle is preferably disposed in a recess 86 of the door 56 such that the paddle handle 70 is substantially flush with the outer door panel 88 of the door 56.

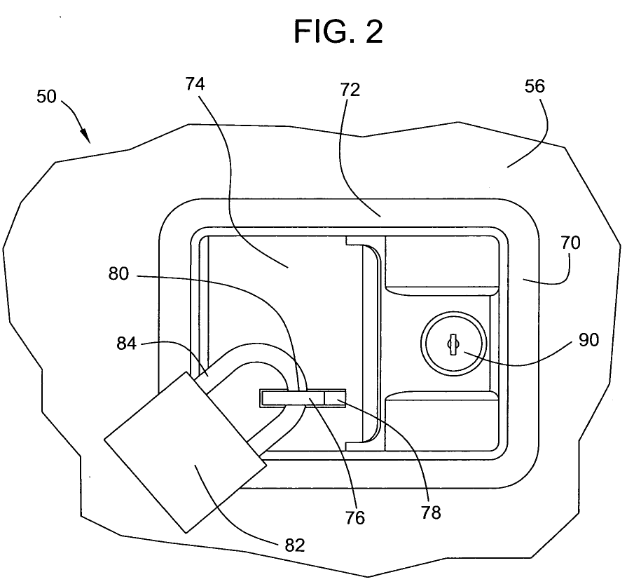

Referring to FIG. 2, the paddle handle 70 can include a second lock 90. The second lock 90 can be operable by a key, for example. When the key-operated lock 90 is locked, the lock 90 can prevent the actuation of the paddle handle 70, which thereby prevents the safety cabinet 50 from opening. Accordingly, the safety cabinet 50 can include two locking means 82, 90 which both can be locked to selectively retain the operating lever 74 in the normal position, thereby locking the safety cabinet 50. Access to the safety cabinet 50 may be significantly restricted as a user may need to unlock both the padlock 82 and the key-operated lock 90 to access the cabinet 50. The padlock 82 and the key-operated lock 90 operate independently in that the state of one lock has no bearing on the state of the other lock. At any time, both locks 82, 90 may be locked, both locks 82, 90 may be unlocked, the padlock 82 may be locked and the key-operated lock 90 may be unlocked, or the padlock 82 may be unlocked and the key-operated lock 90 may be locked. In other embodiments, the safety cabinet may not include a key-operated lock. In yet other embodiments, the second lock can be a combination lock, for example.

Referring to FIG. 5, the enclosure 52 has a double-walled construction. Accordingly, the enclosure 50 can have an outer shell 92 and an inner shell 94. Referring to FIG. 6, the left and right doors 54, 56 each has a double-walled construction similar to the enclosure 52. Such a double-walled construction helps to insulate the interior 96 of the safety cabinet 50 from elevated temperatures outside of the safety cabinet.

Referring to FIG. 5, the latch system 68 of the safety cabinet can include the paddle handle 70, a first slide plate 100, a second slide plate 102, a bullet slam latch 104, a first latch rod assembly 106, and a second latch rod assembly 108. The latch system 68 may be substantially the same as the latch system of U.S. Pat. No. 6,729,701, except for those differences discussed above with respect to the paddle handle 70. When the doors 54, 56 are closed, the bullet latch 104 and the latch rod assemblies 106, 108 engage the left door 54 and the enclosure 52, respectively, to secure the doors 54, 56 closed. By actuating the paddle handle 70, the bullet latch 104 and the latch rod assemblies 106, 108 can be disengaged from the left door 54 and the enclosure 52, respectively. Actuating the paddle handle 70 allows a user to open the door 56. The right door 56 can only be opened by actuation of the paddle handle 70. The left door 54 can be secured closed by the right door 56. Therefore, when either the padlock or the second lock 90 is locked, thereby preventing actuation of the paddle handle 70, the doors 54, 56 cannot be opened and the safety cabinet 50 can not be accessed. However, the latch system 68 is configured such that the doors 54, 56 are movable from the open position to the closed position without the actuation of the paddle handle 70.

Referring to FIG. 5, the first and second slide plates 100, 102 are moveably mounted so as to respond to actuation of the paddle handle 70. The first and second latch rods 106, 108 are respectively mounted to the first and second slide plates 100, 102. The latch rods 106, 108 can be moveable between an extended position and a retracted position. The first and second latch rods 106, 108 can be configured to engage the enclosure 52 to selectively retain the door 56 when in the extended position. The latch rods 106, 108 are biased to the extended position such that portions 110, 112 of the first and second latch rods 106, 108 projects from first and second openings 114, 116, respectively, of the door 56. The latch rods 106, 108 can move to the retracted position upon actuation of the paddle handle 70. The bullet slam latch 104 is mounted to the paddle handle 70. The bullet slam latch 104 includes a catch 120, which can be operably arranged with the paddle handle 70 and moveable between an extended position and a retracted position. The catch 120 can be biased to the extended position such that the catch 120 projects from a third opening 122 of the door 56. The catch 120 is configured to selectively retain the door 56 when in the extended position. The catch 122 can move to the retracted position upon actuation of the paddle handle 70.

Referring to FIG. 6, the safety cabinet can further comprise a closure system 130 operably arranged with the doors 54, 56 to bias the doors 54, 56 to the closed position. The safety cabinet 50 can also comprise comprising a retaining system 132 to selectively retain the doors 54, 56 in the open position. The closure system 130 and the retaining 132 system of the safety cabinet 50 may be substantially the same as the closure and retaining systems of U.S. Pat. No. 6,729,701. Accordingly, the retaining system 132 may retain the doors 54, 56 in a open position until the retaining system 132 in disengaged or overcome by the closure system 130. The retaining system 132 can include first and second fusible links 134, 136 which are mounted to the right and left doors 54, 56, respectively, and the enclosure 52. The fusible links 134, 146 can be constructed such that the fusible links 134, 136 will fuse when the ambient temperature is above a selected level to thereby detach the links 134, 136 from the enclosure to allow the closure system 130 to move the doors 54, 56 to the closed position.

In the event of fire, for instance, the closure system 130 cooperates with the fusible links 134, 136 to automatically close the doors 54, 56. When the ambient temperature exceeds the predetermined level, the first fusible link 134 and the second fusible link 136 melt. The first and second air cylinders 140, 142 of the closure system 130 can act to move the right and left doors 56, 54, respectively, to the closed position. The closure system 130 provides an assist feature during the manual closing of the doors 54, 56 by urging the doors 54, 56 to the closed position once the retaining system 132 is overcome.

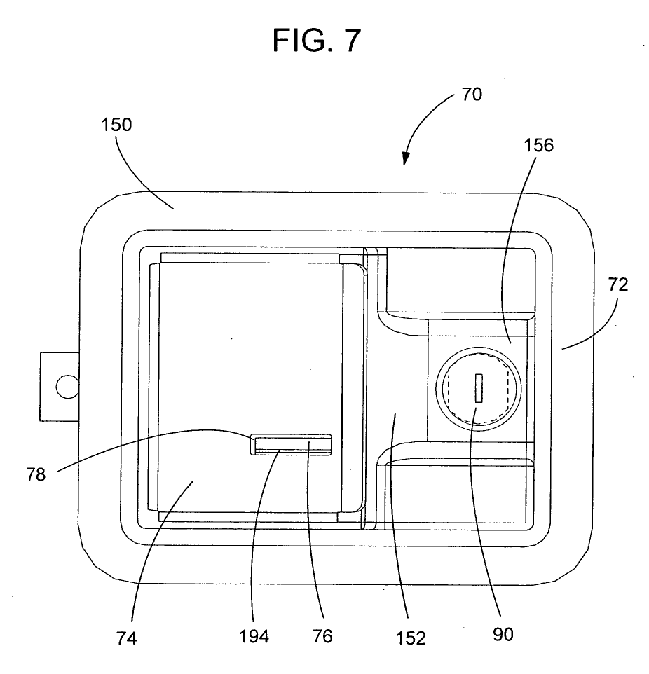

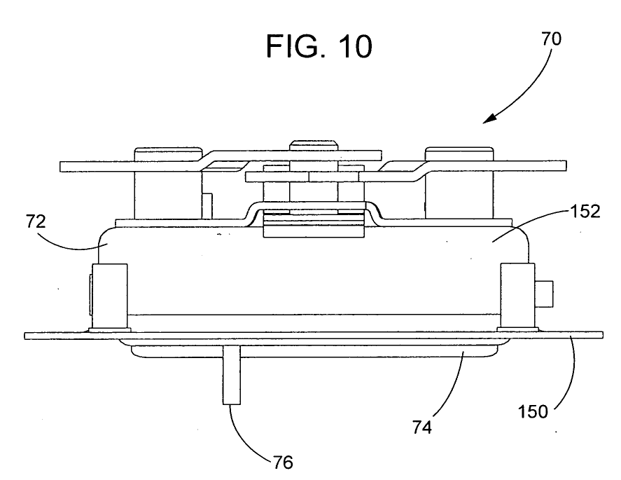

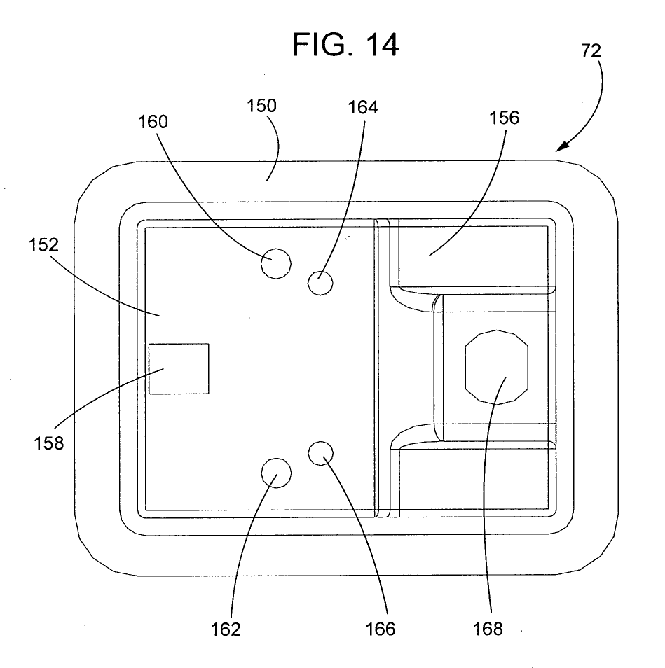

Referring to FIG. 7, the housing 72 of the paddle handle 70 can include a rim 150 surrounding a pan 152. The operating lever 76 can be disposed within the pan 152 such that it is substantially flush with the rim 150 when the operating lever 74 is in the normal position. The pan 152 can include a raised area 156 to the right of the operating lever 74. The key-operated lock 90 can be disposed on the raised area 156 such that the operating lever 74 does not interfere with the key-operated lock 90. The tang 76 is disposed in the pan 152 below the operating lever 74 but extending out past the slot 78 in the lever 74, as shown in FIG. 10. Referring to FIG. 14, the housing 72 can include six holes 158, 160, 162, 164, 166, 168.

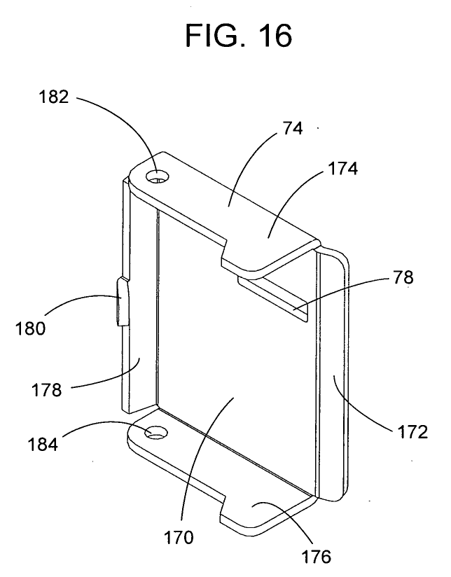

Referring to FIG. 16, the operating lever 74 can include a planar portion 170, a lip 172, a first sidewall 174, a second sidewall 176, a rear wall 178, and an actuator piece 180 depending from the rear wall 178. The slot 78 can be located in the planar portion 170. The first and second sidewalls 174, 176 can include first and second openings 182, 184, respectively.

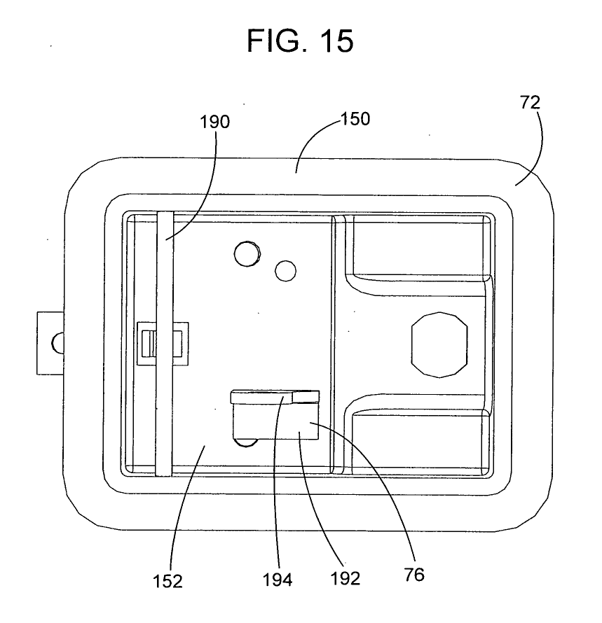

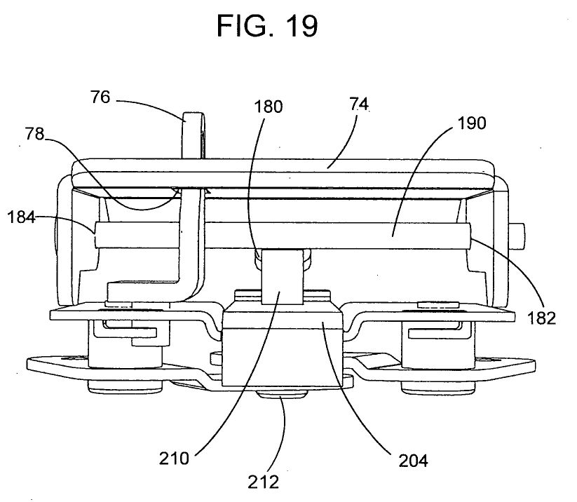

Referring to FIG. 15, the housing 172 can include a pin 190 mounted to the pan 152 of the housing 72. The operating lever can be pivotally mounted to the housing 72 via the pin 190. Referring to FIG. 19, the first and second pin holes 182, 184 of the operating lever 74 can receive the pin 190 therethrough. The pin 190 defines an axis about which the lever 74 pivots from the normal position to the operating position.

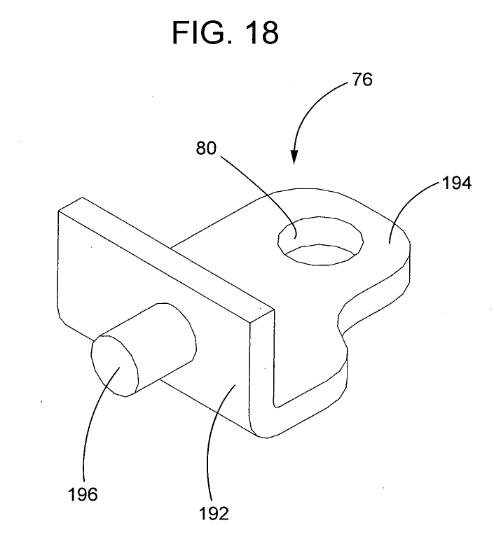

Referring to FIG. 18, the tang 76 includes a base 192, a stem 194 defining the padlock opening 80, and a root 196. Referring to FIG. 15, the base 192 of the tang 76 is mounted flush against the pan 152. The root 196 can extend through the fifth hole of the housing 72 to position and secure the tang 76 on the housing 72. The tang 76 can be welded to the housing 72. In other embodiments, the tang can be riveted to the housing. In yet other embodiments, any other suitable fastening technique can be used.

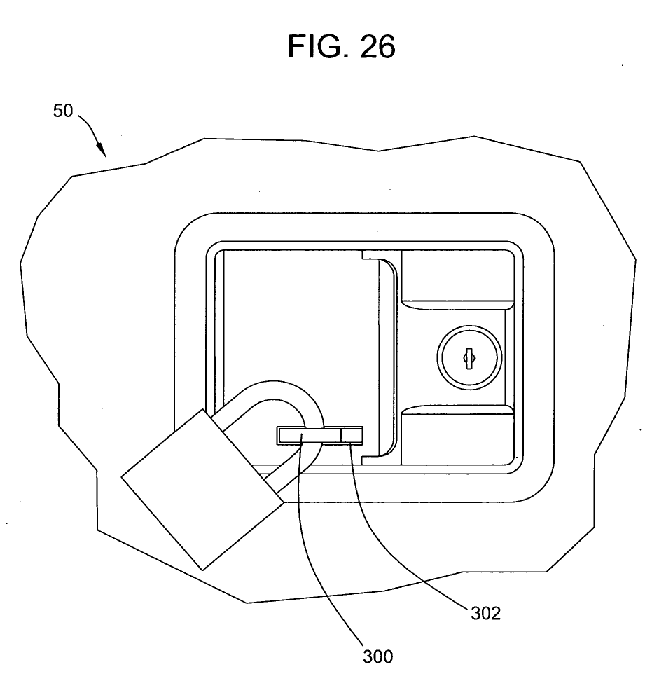

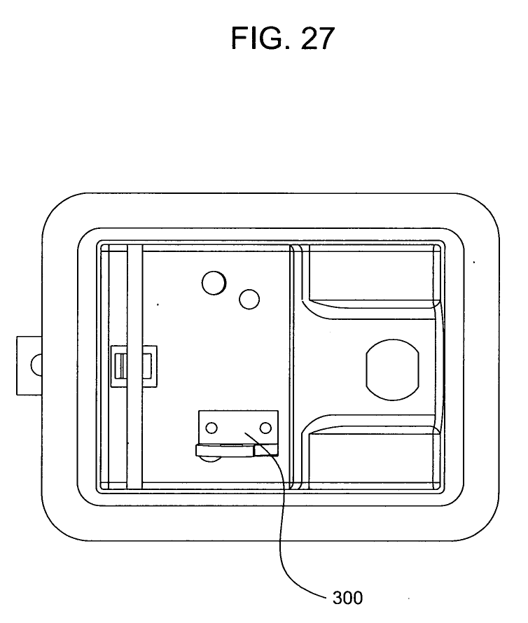

Referring to FIG. 7, the tang 76 can be positioned on the housing 72 such that the stem 194 of the tang 76 extends from the pan 152 through the slot 78 of the operating lever 74 a predetermined distance when the operating lever 74 is in the normal position such that the padlock opening 80 is accessible. The tang 76 can be configured so that the tang 76 will not interfere with operating lever 74 as it moves to the operating position. In other embodiments, the tang 300 and slot 302 can be arranged as shown in FIGS. 26 and 27.

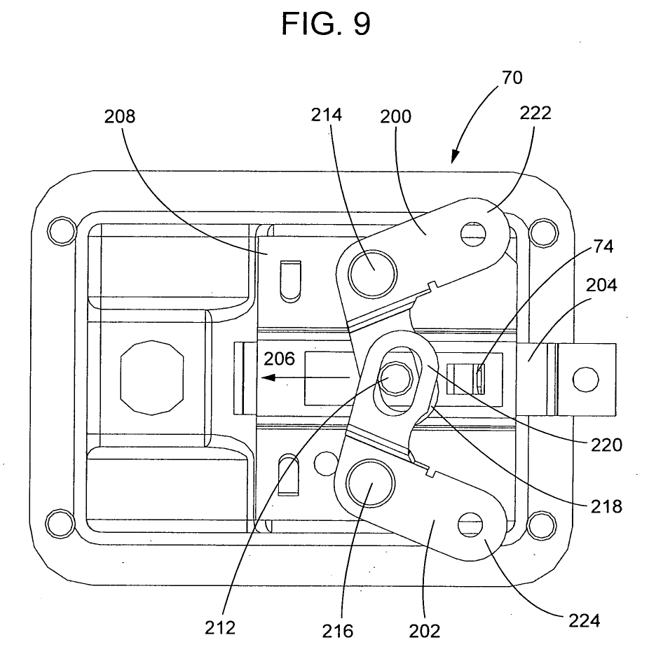

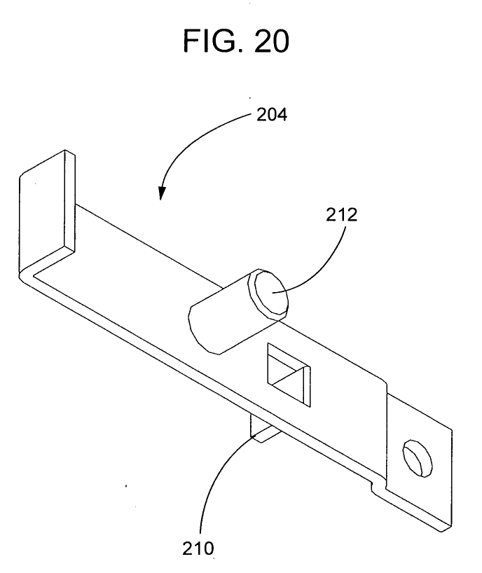

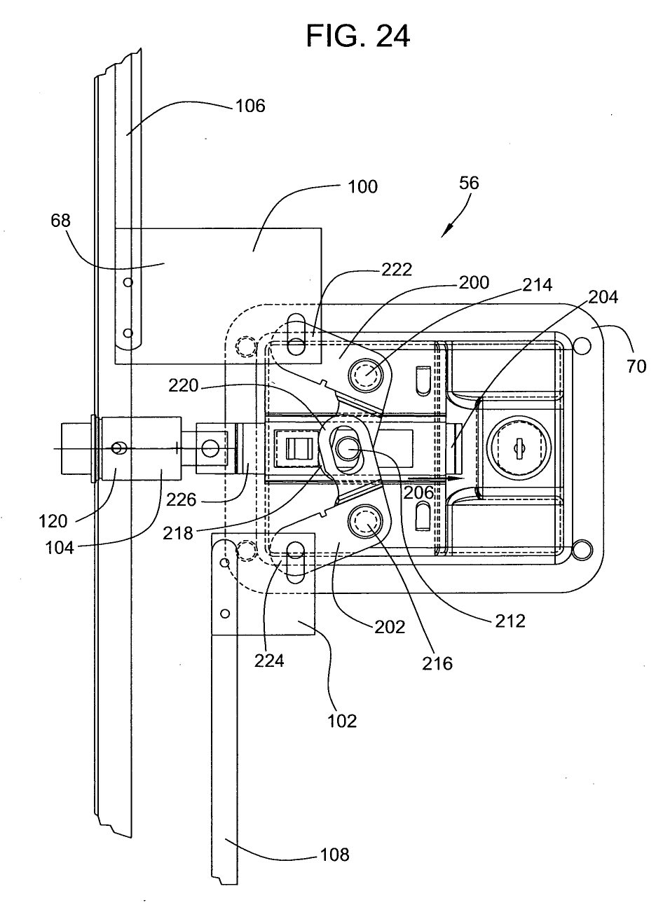

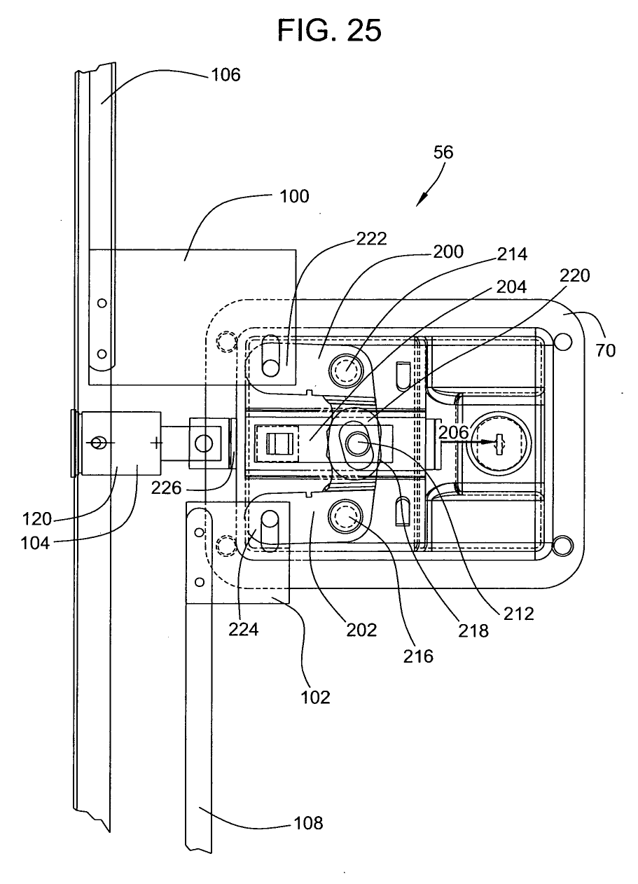

Referring to FIG. 9, the paddle handle 70 also includes a first handle linkage 200, an opposing second handle linkage 202, and a slide 204. The operating lever 74 is operably arranged with the slide 204 such that moving the operating lever 74 to the operating position moves the slide 204 in a slide actuating direction 206. The paddle handle 70 includes a slide plate 208 to house the slide 204. Referring to FIG. 20 the slide includes an engagement piece 210 and a slide pin 212. Referring to FIG. 19, the actuator piece 180 of the operating lever 74 will engage the engagement piece 210 of the slide 204 as the operating lever 74 moves from the normal position to the operating position. The operating lever 74 will thereby slide the slide 204 in a slide actuating direction 206 from the normal position, as shown in FIG. 24, to the operating position, as shown in FIG. 25.

Referring to FIG. 9, the first and second handle linkages 200, 202 are pivotally mounted to first and second linkage pivot pins 214, 216, respectively. The first and second linkages 200, 202 each include an elongated slot disposed at a respective proximal end. The proximal ends 218, 220 of the first and second linkages 200, 202 are disposed in an overlapping manner such that the slots have the slide pin 212 disposed therein. Referring to FIGS. 24 and 25, the first and second handle linkages 200, 202 are journaled to the slide 204 by the slide pin 212 such that when the slide 204 moves in the slide actuating direction 206, the distal ends 222, 224 of the first and second handle linkages 200, 202 rotate toward each other in opposing linkage actuating directions respectively. The slide pin 212 will rotate the distal ends 222, 224 of the first and second handle linkages 200, 202 from a normal position, as shown in FIG. 24, to an operating position, as shown in FIG. 25.

Referring to FIG. 24, the first and second slide plates 100, 102 are slidably mounted to the first and second linkages 200, 202, respectively, of the paddle handle 70. The bullet slam latch 104 is mounted adjacent to a distal end 226 of the slide 204. The bullet slam latch 104 includes a catch 120. The catch 120 provides a latch point for the latch system 68 to selectively retain the door 56 in the closed position.

Referring to FIG. 25, to open the door 56, a user operates the latch system 68 by pulling the operating lever 74 of the paddle handle 70 to move the slide 204 in the slide actuating direction 206, thereby retracting the catch 120 of the bullet slam latch 104 and actuating the handle linkages 200, 202. The handle linkages 200, 202 move the slide plates 100, 102, respectively, toward each other. As shown in FIG. 25, the operating lever is in the operating position. The latch rods 106, 108 and the bullet slam latch 104 are in the retracted positions and withdrawn from the associated apertures of the enclosure and the aperture of the left door, respectively. The right door can be moved to an open position, followed by the left door. To close the door a user simply closes the door without actuating the operating handle as the latch rod assemblies and bullet latch will permit the right door to shut and the reengage the enclosure and the left door, respectively.

Referring to FIG. 1, when the left and right doors 54, 56 are returned to a closed position, a user can lock the padlock 82 to the tang 76 to lock the safety cabinet 50 closed. The user can also lock the key-operated lock 90 to further lock the safety cabinet 50 closed. The paddle handle 70 can now not be actuated. The latch system 68 will not permit the doors 54, 56 to open, and the latch system cannot be released until the locks 82, 90 are both unlocked to thereby allow the paddle handle 70 to be actuated.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A safety cabinet comprising;
an enclosure defining an opening;
a door rotatably attached to the enclosure, the door movable between an open position and a closed position, the door configured to selectively cover the enclosure when in the closed position; and
a latch system arranged with the door to selectively retain the door in the closed position, the latch system including a paddle handle to selectively release the latch system, the paddle handle disposed on the door, the paddle handle including:
a housing,
an operating lever to actuate the paddle handle, the operating lever being moveable between a normal position and an operating position, the operating lever including a slot that passes therethrough, and
a tang, the tang extending through the slot of the operating lever when the operator lever is in the normal position, the tang having a hole therethrough to receive a padlock, the tang configured such that when a padlock passes through the hole of the tang the padlock will prevent the operating lever from actuating the paddle handle.

2. The safety cabinet of claim 1 wherein the door includes a recess in an outer surface, the paddle handle being disposed in the recess of the door such that the paddle handle is substantially flush with the outer surface of the door.

3. The safety cabinet of claim 1 wherein the housing includes a rim surrounding a pan, the operating lever disposed within the pan such that the operating lever is substantially flush with the rim of the housing when the operating lever is in the normal position.

4. The safety cabinet of claim 3 wherein the paddle handle includes a pin defining a longitudinal axis, the operating lever being pivotally attached to the housing via the pin such that the operating lever pivots from the normal position to the operating position about the longitudinal axis of the pin.

5. The safety cabinet of claim 1 wherein the tang is attached to the housing of the paddle handle.

6. The safety cabinet of claim 5 wherein the operating lever pivots with respect to the tang such that the tang is not disposed within the slot of the operating lever when the operator lever is in the operating position.

7. The safety cabinet of claim 1 further comprising a padlock that is selectively lockable to the tang, the padlock extendible through the hole of the tang such that the padlock prevents the operating lever from moving from the normal position to the operating position.

8. The safety cabinet of claim 1 wherein the operating lever is biased to the normal position.

9. The safety cabinet of claim 1 further comprising a lock, the lock being operable by a key, the lock preventing the actuation of the paddle handle when locked.

10. The safety cabinet of claim 1 wherein the enclosure comprises a double-walled construction.

11. The safety cabinet of claim 1 wherein the door comprises an outer panel and an inner panel that define an insulative air space.

12. The safety cabinet of claim 1 further comprising a second door rotatably attached to the enclosure, the second door being rotatable between an open position and a closed position, the doors, when in the closed position, cooperating with each other to cover the opening of the enclosure.

13. The safety cabinet of claim 1 wherein the latch system includes first and second latch rods, the latch rods being moveable between an extended position and a retracted position, the first and second latch rods being configured to engage the enclosure to selectively retain the door when in the extended position, the latch rods being biased to the extended position such that a portion of the first and second latch rods projects from first and second openings, respectively, of the door, the latch rods moving to the retracted position upon actuation of the paddle handle, and a bullet slam latch mounted to the paddle handle, the bullet slam latch having a catch, the catch being operably arranged with the paddle handle and moveable between an extended position and a retracted position, the catch being biased to the extended position such that the catch projects from a third opening of the door, the catch being configured to selectively retain the door when in the extended position, the catch moving to the retracted position upon actuation of the paddle handle, and wherein the latch system is configured such that the door is movable from the open position to the closed position without the actuation of the paddle handle.

14. The safety cabinet of claim 13 wherein the latch system includes first and second slide plates, the first and second slide plates moveably mounted so as to respond to actuation of the paddle handle, the first and second latch rods respectively mounted to the first and second slide plates.

15. The safety cabinet of claim 14 wherein the paddle handle further includes a first handle linkage and an opposing second handle linkage, the first and second handle linkages being pivotally mounted such that actuating the operating lever rotates distal ends of the handle linkages toward each other, the first and second handle linkages each including a linkage pin, and the first and second slide plates each includes a slot, each slot of the first and second slide plates having a respective linkage pin of the first and second handle linkages disposed therein to slidably mount the first and second slide plates to the first and second handle linkages, respectively.

16. The safety cabinet of claim 1 further comprising a closure system operably arranged with the door to bias the door to the closed position.

17. The safety cabinet of claim 16 further comprising a retaining system to selectively retain the door in the open position, the retaining system having a fusible link, the fusible link being constructed such that the fusible link will fuse when the ambient temperature is above a predetermined level to thereby allow the closure system to move the door to the closed position.
